(19) United States
(12) Patent Application Publication
(10) Pub. No.: US 2026/0225857 A1
(43) Pub. Date: Aug. 6, 2026

(54) METHOD FOR INSTALLING A LIFT SYSTEM

(71) Applicant: INVENTIO AG, Hergiswil (CH)

(72) Inventors: Raphael Bitzi, Luzern (CH); Christian Studer, Kriens (CH); Bjarne Lindberg, Hellbuhl (CH)

(21) Appl. No.: 19/151,788

(22) PCT Filed: Mar. 11, 2024
(86) PCT No.: PCT/EP2024/056316

§ 371 Date: Jul. 29, 2025

(30) Foreign Application Priority Data
Mar. 27, 2023 (EP) 23164408.9

(51) Int. Cl. B66B 19/00; B66B 11/00

(52) U.S. Cl. CPC B66B 19/00; B66B 11/0005

(57) ABSTRACT

The invention relates to a method for installing an elevator system. The method comprises the method steps of providing a wall element a manufacturing site and arranging elevator components on the wall element at the manufacturing site. According to the invention, the method steps of transporting the wall element from the manufacturing site to an installation site of the elevator system and arranging the wall element are additionally carried out in such a way that the wall element only forms a shaft space of the vertically extending elevator shaft at the installation site together with walls of the elevator shaft, in which shaft space an elevator car of the elevator system can be arranged in a displaceable manner.

The invention relates to a method for installing an elevator shaft of an elevator system according to the preamble of claim 1.

The installation of an elevator system is complex and therefore involves considerable costs. In particular, the creation of an elevator shaft for an elevator system, e.g., when constructing a building, and the subsequent installation of elevator components in the elevator shaft, is quite complex. Usually, the elevator shaft is first created completely inside the building receiving the elevator system, and the elevator system with its elevator components such as the elevator car, counterweight, drive machine, and guide rails is subsequently installed in the elevator shaft. It has already been proposed to create the elevator shaft from several prefabricated shaft modules with shaft walls in which elevator components, such as guide rail pieces, are already at least partially pre-assembled. Prefabrication and pre-assembly do not take place at the construction site of the building accommodating the elevator, i.e., at the elevator system installation site, but in a factory and thus at a manufacturing site. This procedure requires less time at the installation site. In addition, this procedure has positive effects on the quality of the installation and on the working safety of the installation personnel. A prefabricated shaft module encloses a cavity in the form of a shaft space, which can at least partially accommodate an elevator car. It is thus very voluminous, so that the transport of such shaft modules from the manufacturing site to the installation site can usually only be achieved with special transport means. The transport is therefore very complex, time-consuming and expensive. Also, the transport is quite inefficient since the hollow shaft spaces mentioned cannot be used to transport other parts and thus the capacity of the transporter cannot be used effectively.

DE 2755267 A1 describes, at least implicitly, a method for installing an elevator system with an elevator shaft, in which various types of wall elements in the form of reinforced concrete slabs are provided at a manufacturing site. Four wall elements are assembled at the manufacturing site to form a shaft module that encloses a shaft space. Elevator components in the form of guide rail pieces and one or two shaft doors are arranged in the shaft module and thus on the wall elements. The shaft module manufactured in this way is transported to an installation site of the elevator system, where it is assembled together with other shaft modules to form an elevator shaft.

In contrast, it is a particular object of the invention to propose a method for installing an elevator system which enables simple and cost-effective installation. In particular, the aim is to enable simple, efficient and cost-effective transport of prefabricated wall elements of an elevator shaft of the elevator system, which are provided with elevator components, to the installation site of the elevator system. According to the invention, this object is achieved by a method having the features of claim 1.

The method according to the invention for installing an elevator system comprises the method steps of providing a wall element at a manufacturing site and arranging elevator components on the wall element at the manufacturing site. According to the invention, the method steps of transporting the wall element from the manufacturing site to an installation site of the elevator system and arranging the wall element are additionally carried out in such a way that the wall element only forms a shaft space of the vertically extending elevator shaft at the installation site together with walls of the elevator shaft, in which shaft space an elevator car of the elevator system can be arranged in a displaceable manner. The above-mentioned method steps are carried out in the order specified.

In the method according to the invention, unlike in DE 2755267A1 , a shaft module enclosing a shaft space is not constructed from wall elements at the manufacturing site and transported to the installation site. Instead, one or more wall elements, in particular those that are much more manageable and do not enclose a shaft space, are transported from the manufacturing site to the installation site, and an elevator shaft in which an elevator car of the elevator system can be arranged in a displaceable manner is created only at the installation site using the wall element(s). At the same time, the above-mentioned advantage of prefabricated shaft modules is preserved, namely that elevator components can be arranged on wall elements at the manufacturing site.

In addition to the above-mentioned method steps, the method in particular comprises the further method steps of providing an elevator car and optionally a counterweight, and arranging the elevator car and optionally the counterweight in the elevator shaft such that the elevator car and optionally the counterweight can be displaced vertically in the elevator shaft.

In the following, directional information such as above, below, and lateral or vertical and horizontal refers to the alignment of the respective component during an operating state of the elevator system. In this case, the operating state of the elevator system is understood to be the state after completion of the installation and commissioning of the elevator system. In the operating state of the elevator system, people and/or goods can thus be transported in the elevator car between floors of the building in which the elevator system is located.

Providing a wall element at the manufacturing site shall be understood here to mean that the wall element is manufactured at or delivered to the manufacturing site. The wall element has in particular a cuboid basic shape and can, for example, be constructed mainly from reinforced concrete, wood or metal, in particular steel.

At the manufacturing site, elevator components, in particular so-called shaft material, such as rail brackets, i.e., so-called brackets and guide rail pieces, are arranged on the wall element and thus fastened to the wall element. Additionally or alternatively, a drive machine or a shaft door can also be arranged on the wall element. The elevator components are screwed in particular directly or indirectly to the wall element. It is also possible to arrange holders, brackets or similar aids for connecting a wall element to a wall adjacent to the elevator shaft created with the wall element on the wall element at the manufacturing site or to provide them already during the manufacture of the wall element, for example by embedding them in concrete.

In order to protect the parts arranged on the wall element from damage and/or to enable or facilitate stacking of wall elements equipped with elevator parts, additional parts, such as wooden, polystyrene or plastics blocks, can be temporarily arranged on the wall element. These parts are removed again when the installation of the elevator system continues at the installation site.

The wall element provided with elevator components, in particular several wall elements, are transported with a suitable vehicle, in particular a truck, to the installation site of the elevator system, i.e., in particular to a construction site of a building accommodating the elevator system. Transport takes place, in particular partly, on public roads. The installation site can also be in the immediate vicinity of the construction site mentioned.

In particular, several wall elements are stacked on top of each other on the corresponding vehicle, which enables efficient transport of the wall elements.

It is also possible that wall elements are transported from more than one manufacturing site to the installation site and further processed there. This is advantageous in particular when using different types of wall elements, allowing different manufacturing sites to specialize in providing different wall elements.

At the installation site, the elevator shaft of the elevator system is created using the wall element. The wall element is arranged, in particular by means of a crane, opposite the walls of the elevator shaft such as to form a shaft space together with the said walls. The wall element and the mentioned walls thus also form a first section of the vertically extending elevator shaft, extending in the vertical direction. The walls mentioned can also consist of a wall element which, as described, was provided with elevator components at a manufacturing site and then transported to the installation site. However, it is also possible that one or all of the walls mentioned were constructed at the installation site, for example cast in concrete.

The wall element is connected in particular to adjacent walls of the elevator shaft. Appropriate brackets or other suitable connecting elements can be used for this purpose. Connecting elements for connecting prefabricated components, such as concrete elements, are available on the market in various designs.

The elevator shaft of the elevator system can be designed in such a way that a single elevator car can be moved vertically within a travel path in the elevator shaft. However, it is also possible for the elevator shaft to be designed in such a way that more than one, e.g., two or three, elevator cars can be moved vertically next to each other and independently of each other. In this case, the elevator shaft has several travel paths arranged next to each other.

The elevator shaft of the elevator system has, in particular, a rectangular cross section. However, it is also possible that the elevator shaft has a different shape.

In one embodiment of the invention, the wall element is constructed from different materials. The use of different materials makes it possible to adapt the properties of the wall element particularly well to the respective requirements. The wall element can, for example, have a metal frame clad with wood, in particular a steel frame. Other material combinations in addition to the material combination of wood and metal are possible.

In one embodiment of the invention, several wall elements and different types of wall elements are used to install the elevator system. For example, wall elements can be used to form side walls, rear walls, front walls or intermediate walls of the elevator shaft. A wall element can also form a shaft ceiling. An intermediate wall is provided to separate two travel paths arranged next to each other. In case of a wall element for forming an intermediate wall, elevator components, in particular guide rail pieces, can be arranged on two opposite sides at the manufacturing site.

A side wall of the elevator shaft is understood here to mean a wall on which a guide rail for guiding the elevator car is arranged when the elevator system is in operation. A side wall thus does not have a door opening in which a shaft door is arranged when the elevator system is in operation. A front wall of the elevator shaft is understood here to mean a wall with a door opening in which a shaft door is arranged when the elevator system is in operation. A rear wall of the elevator shaft is understood here to mean a wall of the elevator shaft opposite a front wall. A rear wall can also have a door opening corresponding to the door opening in the front wall.

The different types of wall elements can have different heights, i.e., different vertical extensions. For example, the height of wall elements for forming side walls and/or intermediate walls can be adjusted to a standard length of guide rail pieces. For example, guide rail pieces available on the market in Europe usually have a length of 2.5 or 5 m. The height of wall elements for forming side walls and/or intermediate walls then advantageously has the aforementioned usual rail length or a multiple thereof, for example 2.5, 5, 7.5 or 10 m. This advantageously allows the use of guide rails with standard market lengths, which are more cost-effective than guide rails with different lengths.

The height of wall elements for forming front walls and/or rear walls can be adjusted to the floor height of the building accommodating the elevator system. The height of the wall element corresponds in particular to the floor height or a multiple of the floor height. In case of a floor height of 2.3 m, for example, the height of the wall element is in particular 2.3, 4.6 or 6.9 m. The use of such wall elements for forming front walls and/or rear walls enables a particularly simple and therefore cost-effective installation of the elevator system.

In one embodiment of the invention, different types of wall elements are constructed from different materials. This means that the properties of a type of wall element can be particularly well adapted to specific requirements. For example, wall elements for forming side walls and rear walls can be made of concrete or at least mainly of concrete, and wall elements for forming front walls can be made of metal and/or wood or at least mainly of metal and/or wood. It is also possible that wall elements for forming side walls and rear walls are made of metal or at least mainly of metal, and wall elements for forming front walls are made of wood or at least mainly of wood.

In one embodiment of the invention, a shaft door and in particular several shaft doors are arranged on the wall element at the manufacturing site. The installation of shaft doors is particularly time-consuming and, due to the height of an existing elevator shaft, is not without risk. The installation of one or more shaft doors on a wall element at the manufacturing site saves a great deal of time and significantly reduces the risks for the installation personnel at the installation site.

A wall element with one or more shaft doors forms a front wall or a rear wall in the elevator shaft. The wall element can extend horizontally over one or more adjacent travel paths for an elevator car; it can therefore have one shaft door or several adjacent shaft doors. In the vertical direction, it can extend over one floor or over several floors; it can therefore have one shaft door or several shaft doors arranged one below the other. The wall element can also have shaft doors arranged side by side or one below the other.

In one embodiment of the invention, the wall element has a cavity which is filled with filling material at the installation site. The filling material comprises in particular concrete or is made of concrete. This makes the wall element particularly light, which allows for particularly easy transport of the wall element from the manufacturing site to the installation site.

The wall element thus forms a so-called permanent formwork, which is filled with the filling material, in particular concrete, only at the installation site. The concrete is poured into the cavity of the wall element in liquid form and hardens around the wall element. The hardened concrete then has a structural function within the building accommodating the elevator system. It is also possible for the filling material to be sand, insulation material, damping material or soundproofing material. In this case, the filling material does not have a structural function, but only has functional tasks.

In one embodiment of the invention, a section of the elevator shaft is created at the installation site from various types of wall elements and is then placed on top of an already existing section of the elevator shaft. This means that a shaft module comparable to a shaft module described in DE 2755267 A1 is created at the installation site from various types of wall elements. This can be done independently of the already existing section of the elevator shaft and, in particular, outside the building accommodating the elevator system. This makes construction particularly efficient and safe and also allows for drawing on existing experience with placing prefabricated shaft modules when placing the created section. This procedure is particularly advantageous if the wall elements used to create a shaft module all have the same height.

As an alternative to the described construction of a shaft module from wall elements at the installation site, individual wall elements can also be arranged at or on an existing section of the elevator shaft and connected to already existing walls of the elevator shaft. This procedure is particularly advantageous if the different types of wall elements have different heights at least in part.

In one embodiment of the invention, a base module is delivered to the installation site as a shaft module enclosing a shaft space with pre-assembled elevator components and is arranged as a lowermost shaft section of the elevator shaft. Hence, a particularly large number of elevator components have to be installed in a shaft pit and thus in the base module mentioned. It may be necessary, in particular, to install elevator components, for example in the form of a buffer, on a floor of an elevator shaft. The described design of the base module as a prefabricated shaft module allows for arranging a particularly large number of elevator components, which enables a particularly efficient installation of the elevator system. The base module can have a floor which forms the floor of the elevator shaft. It is also possible for the base module to have special brackets that extend into the shaft space and on which elevator components can be arranged.

In one embodiment of the invention, a top module is delivered to the installation site as a shaft module enclosing a shaft space with pre-assembled elevator components and is arranged as an uppermost shaft section of the elevator shaft. A particularly large number of elevator components also have to be installed in a so-called shaft head and thus in the top module. It may be necessary, in particular, to install elevator components, for example in the form of electronic components or suspension devices, which are used for further installation or for later maintenance of the elevator system, on the ceiling of an elevator shaft. The described design of the top module as a prefabricated shaft module allows for arranging a particularly large number of elevator components, which enables a particularly efficient installation of the elevator system. The top module can have a ceiling which forms the ceiling of the elevator shaft. It is also possible for the top module to have special brackets that extend into the shaft space and on which elevator components can be arranged.

However, it is also possible for the lowermost and/or the uppermost section of the elevator shaft to be constructed from the wall elements described above. It is also possible for the lowermost section, in particular, to be manufactured entirely at the installation site, in particular to be cast in concrete, and for the wall elements described above to be used on this basis.

In one embodiment of the invention, in addition to the wall element(s) provided with elevator components at the manufacturing site, a wall of the elevator shaft is built at the installation site and elevator components are subsequently arranged on this wall at the installation site. The wall can, for example, be part of a supporting structure of the building accommodating the elevator system, which is advantageously used to form the elevator shaft. This allows the elevator shaft to be designed particularly effectively.

The wall in question is cast in concrete at the installation site. The wall can also be made of wood or metal. Also, more than one wall of the elevator shaft, i.e., two or three walls, can be built at the installation site.

The wall elements described above, which were fitted with elevator components at the manufacturing site, are arranged on the said wall(s). Individual wall elements can be arranged or at least two wall elements can be connected first and then arranged.

Further advantages, features, and details of the invention can be found in the following description of exemplary embodiments and with reference to the drawings, in which like or functionally like elements are provided with identical reference signs. The drawings are merely schematic and are not to scale.

In the drawings:

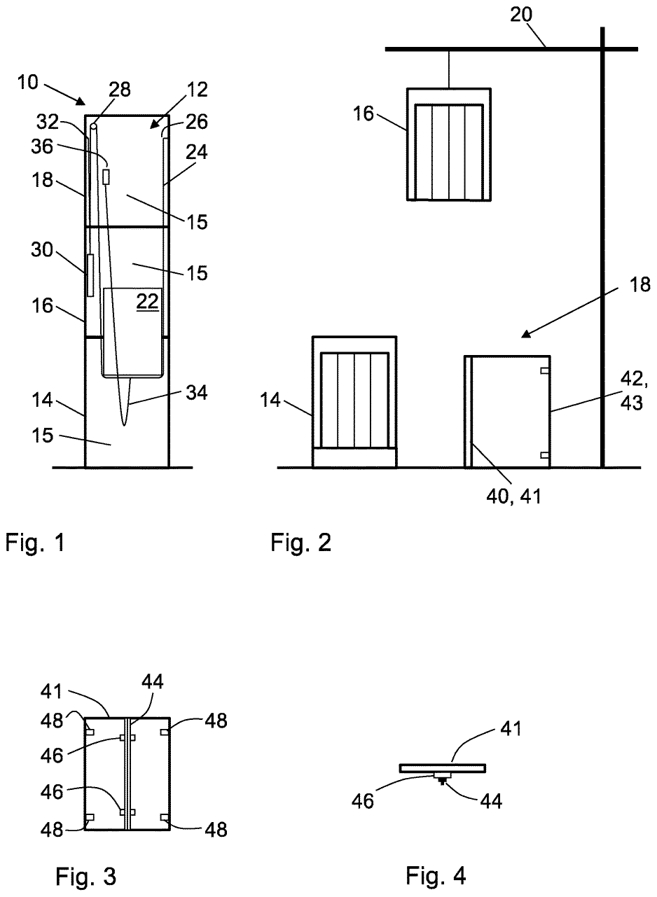

FIG. 1 is an elevator system having an elevator car in an elevator shaft consisting of wall elements,

FIG. 2 is a snapshot of a section of the elevator shaft consisting of wall elements being placed on an already existing section of the elevator shaft,

FIG. 3 is a side wall of a section of an elevator shaft in a view from the front,

FIG. 4 is the side wall of FIG. 3 from above,

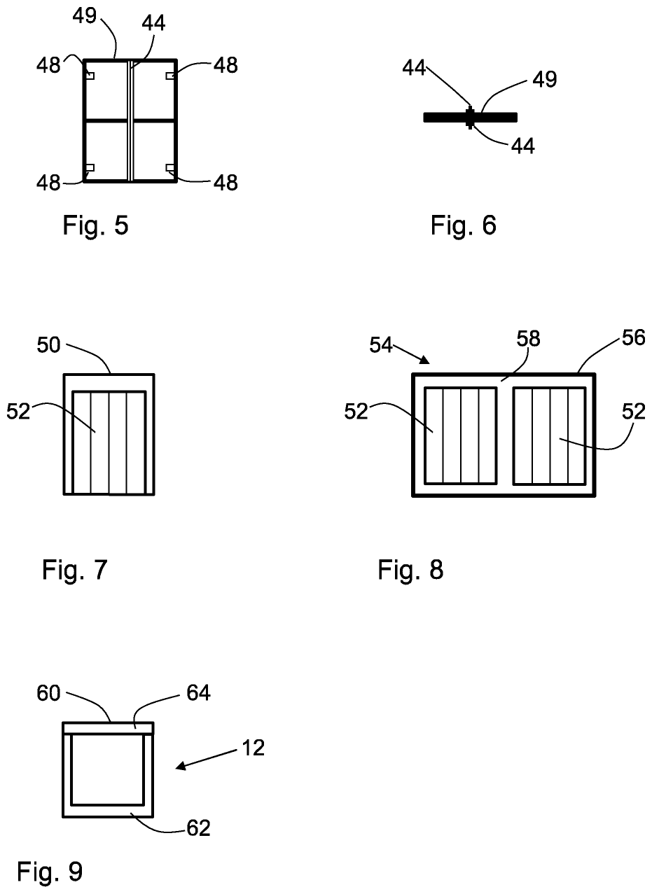

FIG. 5 is an intermediate wall of a section of an elevator shaft in a view from the front,

FIG. 6 is the intermediate wall of FIG. 5 from above,

FIG. 7 is a front wall of a section of an elevator shaft with a shaft door in a view from the front,

FIG. 8 is a front wall of a section of an elevator shaft with two shaft doors in a view from the front, and

FIG. 9 is a top view of an elevator shaft with three walls constructed at an installation site and a front wall consisting of a wall element.

According to FIG. 1, an elevator system 10 has an elevator shaft 12 for a three-story building, which in the present exemplary embodiment is composed of three shaft sections in the form of a base module 14, an intermediate module 16, and a top module 18. The elevator shaft 12 can comprise further, identically designed intermediate modules 16, depending upon the number of floors. The wall elements (41, 43, 50; see FIGS. 2, 3, 4, 7) forming the walls of the mentioned shaft modules 14, 16, 18 are pre-produced and provided with elevator components at a factory, i.e., at a manufacturing site. They are then brought to the construction site, i.e., transported to an installation site of the elevator system 10. At the installation site, the shaft sections are created from different types of wall elements and then placed on top of each other (see FIG. 2 and the associated description).

Each shaft module 14, 16 and 18 encloses a shaft space 15. The shaft modules 14, 16, 18 are placed on top of one another in such a way that the shaft spaces 15 of the shaft modules 14, 16, 18 are aligned vertically and form the vertically extending elevator shaft 12 in which an elevator car 22 of the elevator system 10 is arranged in a displaceable manner. During movement in the elevator shaft 12, the elevator car 22 is guided by guide rails not shown in FIG. 1 (see 44 in FIGS. 3, 4).

The elevator system 10 has a support means 24, the first end 26 of which is fixed in the top module 18. It then extends downwards and around the elevator car 22 and is guided via a drive machine 28, arranged in the top module 18, opposite the first end 26 of the support means 24. From there, it runs through a suspension of a counterweight 30 to its second end 32, which is fixed in the region of the drive machine 28. The drive machine 28 can move the support means 24 and thus the elevator car 22 in the elevator shaft 12.

The elevator car 22 is connected to an elevator controller 36, arranged in the top module 18, via a traveling cable 34. The traveling cable 34 enables a power supply and a communication with the elevator car 22.

FIG. 2 shows how the intermediate module 16 is placed on the first base module 14 from above by means of a crane 20. The base module 14 was previously placed in the same way on a foundation of the elevator shaft 12 (not shown in detail). The base module 14 and the intermediate module 16 were previously assembled from wall elements at the installation site. The individual wall elements were transported from their installation site, i.e., from a factory, to the construction site and thus to the installation site by means of a truck (not shown). The wall elements were first provided at the installation site, i.e., manufactured or delivered, and then provided with elevator components not shown in FIG. 2, such as guide rail pieces, with which elevator components are arranged, in particular screwed, on the wall elements.

FIG. 2 also shows a top module 18 that is not yet fully assembled. A side wall 40 of the top module 18 is formed by a wall element 41, at which a guide rail piece (see 44 in FIGS. 3 and 4) not shown in FIG. 2 was arranged at the installation site. The side wall 40 of the top module 18 was already connected to a rear wall 42 formed by a wall element 43. To complete the top module 18, a wall element forming another side wall, a wall element forming a front wall with a shaft door and a wall element forming a shaft ceiling are added. The mentioned wall elements are thus arranged at the installation site in such a way that the wall elements together with the walls of the elevator shaft formed by wall elements only form a shaft space of the vertically extending elevator shaft at the installation site.

After the intermediate module 16 has been placed as shown in FIG. 2 and the top module 18 has been completed, the top module 18 is placed onto the intermediate module 16 by means of the crane 20, thus closing the elevator shaft at the top.

It is also possible for the base module and/or the top module to be delivered to the installation site as pre-installed shaft modules and arranged as described.

The wall element 41 shown in FIGS. 3 and 4 for forming a side wall consists of a reinforced concrete slab on which elevator components in the form of a guide rail piece 44 and rail brackets 46 were arranged at the manufacturing site. The guide rail piece 44 was fastened to the wall element 41 in a known manner by means of the rail brackets 46. In the finished elevator shaft 12, the guide rail piece 44, together with the guide rail pieces of other wall elements, forms a continuous guide rail for guiding the elevator car 22.

The wall element 41 has a mainly cuboid basic shape. A holder 48 is embedded in concrete in the region of the four corners of the wall element 41, by means of which the wall element 41 can be connected to adjacent walls or wall elements of the elevator shaft.

It is also possible for the wall element forming a side wall to consist of a wooden panel or metal frame on which elevator components were arranged at the manufacturing site.

The wall element 49 shown in FIGS. 5 and 6 for forming an intermediate wall between two adjacent travel paths for one elevator car each consists of a metal frame, in particular a steel frame, on which a guide rail piece 44 was arranged on each side at the manufacturing site. The guide rail pieces 44 were fastened directly to the metal frame with tabs not shown. A holder 48 is welded on in the region of the four corners of the wall element 49, by means of which the wall element 49 can be connected to adjacent walls or wall elements. Wall elements for forming an intermediate wall do not have to consist of a metal frame; they can also be constructed from a reinforced concrete slab or wood, for example.

So-called Omega brackets can also be arranged on the wall elements forming a side wall or an intermediate wall. An Omega bracket is characterized by the fact that in the finished elevator shaft between the wall element and the Omega bracket there is a travel path for a counterweight of the elevator system. An Omega bracket also typically has three guide rail pieces attached to it: two to guide the counterweight and one to guide the elevator car. The wall element 50 shown in FIG. 7 forms a front wall in a shaft module. The wall element 50 can be made of concrete, wood or metal. A shaft door 52 was arranged on the wall element 50 at the manufacturing site. The shaft door 52 is attached to the wall element 50 by means of tabs and holders on a rear side of the wall element 50 which are hence not visible.

The wall element 54 shown in FIG. 8 also forms a front wall in a shaft module. Two shaft doors 52 were arranged next to each other on the wall element 54 at the manufacturing site. The wall element 54 thus extends over two adjacent travel paths, each for one elevator car. The wall element 54 has a rectangular metal frame 56 to which a wooden panel 58 is attached. The wall element 54 is thus made of metal and wood and thus of different materials.

Other material combinations in addition to the material combination of metal and wood are possible. It is also possible for more than two shaft doors to be arranged next to each other, for several shaft doors to be arranged one below the other, or for shaft doors to be arranged both next to each other and one below the other on a wall element.

It is not necessary for the wall elements delivered from the manufacturing site to the installation site to first be assembled into a shaft module, as described above, which is then placed on top of an existing section of the elevator shaft. Instead, the wall elements can be arranged individually at or on an existing section of the elevator shaft.

The different types of wall elements can have different heights. The height of a wall element forming a side wall can in particular correspond to the standard length of guide rails or a multiple thereof, for example 2.5 or 5 m and multiples thereof. The height of a wall element forming a front wall or a rear wall can, for example, correspond to a floor height of the building accommodating the elevator system or a multiple thereof.

FIG. 9 shows a top view of an elevator shaft 12 in which only one wall is formed by a wall element 60 delivered to the installation site and provided with elevator components at the manufacturing site. The other walls 62 were constructed with concrete at the installation site. The wall element 60 was arranged on the walls using a crane after the walls 62 had been constructed. The wall element 60 has a cavity 64 which is filled with concrete after being arranged on the walls 62. The wall element 60 thus forms a so-called permanent formwork.

Elevator components, not shown, for example in the form of guide rail pieces, are also arranged on the walls 62.

It is also possible to construct only one or two walls of the elevator shaft at the installation site and to form the remaining walls from delivered wall elements.

Finally, it should be noted that terms such as “having,” “comprising,” etc., do not preclude other elements or steps, and terms such as “a” or “an” do not preclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

1. A method for installing an elevator system with an elevator shaft, comprising the method steps of:
providing a wall element at a manufacturing site,
arranging elevator components on the wall element at the manufacturing site,
transporting the wall element from the manufacturing site to an installation site of the elevator system, and
arranging the wall element-in such a way that the wall element -only forms a shaft space of the elevator shaft at the installation site together with walls of the elevator shaft, wherein the elevator shaft extends vertically, and herein an elevator car of the elevator system can be arranged in the shaft space in a displaceable manner.

2. The method according to claim 1, wherein the wall element is constructed from a plurality of different materials.

3. The method according to claim 1, wherein a plurality of different types of wall elements are used for installing the elevator system.

4. The method according to claim 3, wherein the different types of wall elements are constructed from different materials from one another.

5. The method according to claim 1, wherein a plurality of shaft doors are arranged on the wall element manufacturing site.

6. The method according to claim 1, wherein the wall element has a cavity which is filled with a filling material at the installation site.

7. The method according to claim 6, wherein the filling material comprises concrete.

8. The method according to claim 2, wherein a section of the elevator shaft is created at the installation site from various types of wall elements and is then placed on top of an already existing section of the elevator shaft.

9. The method according to claim 8, wherein a base module is delivered to the installation site as a shaft module enclosing a shaft space with pre-assembled elevator components and is arranged as a lowermost shaft section of the elevator shaft.

10. The method according to claim 8, wherein a top module is delivered to the installation site as a shaft module enclosing a shaft space with pre-assembled elevator components and is arranged as an uppermost shaft section of the elevator shaft.

11. The method according to claim 1, wherein a wall of the elevator shaft is built at the installation site and elevator components are arranged on said wall at the installation site.
